(19) United States
(12) Patent Application Publication
(10) Pub. No.: US 2012/0312572 A1
(43) Pub. Date: Dec. 13, 2012

(54) HANDLE ASSEMBLY FOR POWER TOOL

(75) Inventors: Uwe Nemetz, Hunfelden Nauheim (DE); Andreas Friedrich, Limburg (DE); Frantisek Harcar, Lipany (SK)

(73) Assignee: BLACK & DECKER INC., Newark, DE (US)

(21) Appl. No.: 13/489,598

(22) Filed: Jun. 6, 2012

(30) Foreign Application Priority Data
Jun. 7, 2011 (GB) 1109492.7
Jun. 7, 2011 (GB) 1109494.3
Jul. 29, 2011 (GB) 1113116.6
Jul. 29, 2011 (GB) 1113117.4

(51) Int. Cl. B25D 17/04; F16M 13/02

(52) U.S. Cl. 173/162.2; 248/220.22

(57) ABSTRACT

A mounting apparatus for mounting a handle to a power tool is disclosed. The apparatus comprises a base for supporting a handle and engaging a body of the power tool, a flexible strap for engaging the base at first and second locations to form a loop for retaining the support in engagement with the body of the power tool, and a clamping mechanism comprising a pair of wedges for engaging the base and the flexible strap, and a bolt for retaining the wedges in position relative to the base. A knob enables movement of the wedges relative to each other in a first direction to reduce the size of the loop and in a second direction to increase the size of the loop.

### CROSS-REFERENCE TO RELATED APPLICATIONS

Concurrently filed herewith is a U.S. Application which has not yet been assigned a Ser. No., but which has the same inventive entity as the present invention, is entitled “Handle Assembly for Power Tool”, claims priority from GB Patent Application Nos. GB 1109492.7 filed on 7 Jun. 2011 and GB 1113116.6 filed 29 Jul. 2011 in the name of Black & Decker Inc., and is incorporated herein by reference in its entirety. Furthermore, the present application claims priority from GB Patent Application Nos. GB 1109494.3 filed on 7 Jun. 2011 and GB 1113117.4 filed 29 Jul. 2011 in the name of Black & Decker Inc.

### FIELD OF THE INVENTION

The present invention relates to handle assemblies for power tools, and relates particularly, but not exclusively, to vibration damping handle assemblies for use with hammer power drills.

### BACKGROUND OF THE INVENTION

Hammer power drills are known in which a rear handle for operation by a user's hand is provided at a rear part of a tool housing, and a front handle operated by the user's other hand is provided at a forward part of the tool housing. The front handle may be provided with vibration damping means for reducing the transmission of vibrations from the housing of the tool to the user's hand.

GB 2444160 discloses an auxiliary handle for a hand held machine tool in which a supplementary handle is clamped to a machine tool by means of an injection moulded clamping collar. This arrangement suffers from the drawback that the tendency of mechanical stresses to be concentrated in certain regions of the clamping mechanism results in the apparatus being expensive to construct if it is to be sufficiently robust.

Preferred embodiments of the present invention seek to overcome one or more of the above disadvantages of the prior art.

### BRIEF SUMMARY OF THE INVENTION

According to an aspect of the present invention, there is provided a mounting apparatus for mounting a handle to a power tool, the apparatus comprising:

a support for supporting a handle and engaging a body of the power tool;

a flexible member for engaging the support at first and second locations to form a loop for retaining the support in engagement with the body of the power tool;

a retaining mechanism comprising a pair of first members for engaging the support and the flexible member, and retaining means for retaining the first members in position relative to the support; and

adjustment means for causing movement of said first members relative to each other in a first direction to reduce the size of said loop and in a second direction to increase the size of said loop.

By providing a retaining mechanism comprising a pair of first members for engaging the support and the flexible member, and retaining means for retaining the first members in position relative to the support, and adjustment means for causing movement of said first members relative to each other in a first direction to reduce the size of said loop and in a second direction to increase the size of said loop, this provides the advantage of enabling clamping stresses to be spread along the length of the loop, thereby enabling the apparatus to be robustly constructed in a more cost effective manner.

Said first members may be mounted in use adjacent respective ends of said flexible member.

This provides the advantage of enabling the area over which tensioning forces are applied to the flexible member to be increased, thereby improving reliability of the apparatus.

At least one said first member may be slidable relative to said support.

This provides the advantage of enabling the construction of the apparatus to be simplified, thereby reducing its cost.

At least one said first member may be slidable relative to said support by means of mutually engaging surfaces on said first member and said support.

This provides the advantage of enabling the construction of the device to be simplified, and the device to thereby be reduced in cost, by enabling sliding movement of at least one said first member relative to the support to cause movement of the first members towards or away from each other, for example by means of suitable inclined surfaces.

The retaining means may comprise at least one retaining member for engaging said first members.

At least one said retaining member may be adapted to pass through a respective aperture through each said first member.

The adjustment means may engage at least one said retaining member to cause at least one said first member to move relative to said support.

The adjustment means may engage said retaining member by means of respective screw threads provided on said retaining means and said retaining member.

According to another aspect of the present invention, there is provided a handle mechanism comprising a mounting apparatus as defined above, and a handle mounted to said support.

### BRIEF DESCRIPTION OF THE DRAWINGS

Preferred embodiments of the invention will now be described, by way of example only and not in any limitative sense, with reference to the accompanying drawings, in which:

FIG. 1 is a perspective view of a handle assembly of a first embodiment of the present invention;

FIG. 2 is a top view of the assembly of FIG. 1;

FIG. 3 is a side view of the assembly of FIG. 1;

FIG. 4 is a cross sectional view along the line A-A in FIG. 3;

FIG. 5 is a cross sectional view along the line C-C in FIG. 3;

FIG. 6 is a cross sectional view along the line B-B in FIG. 3;

FIG. 7 is a side view of a handle assembly of a second embodiment of the present invention;

FIG. 8 is a cross sectional view along the line A-A in FIG. 7;

FIG. 9 is a cross sectional view along the line B-B in FIG. 7; and

FIG. 10 is a top view of the assembly of FIG. 7.

### DETAILED DESCRIPTION OF THE INVENTION

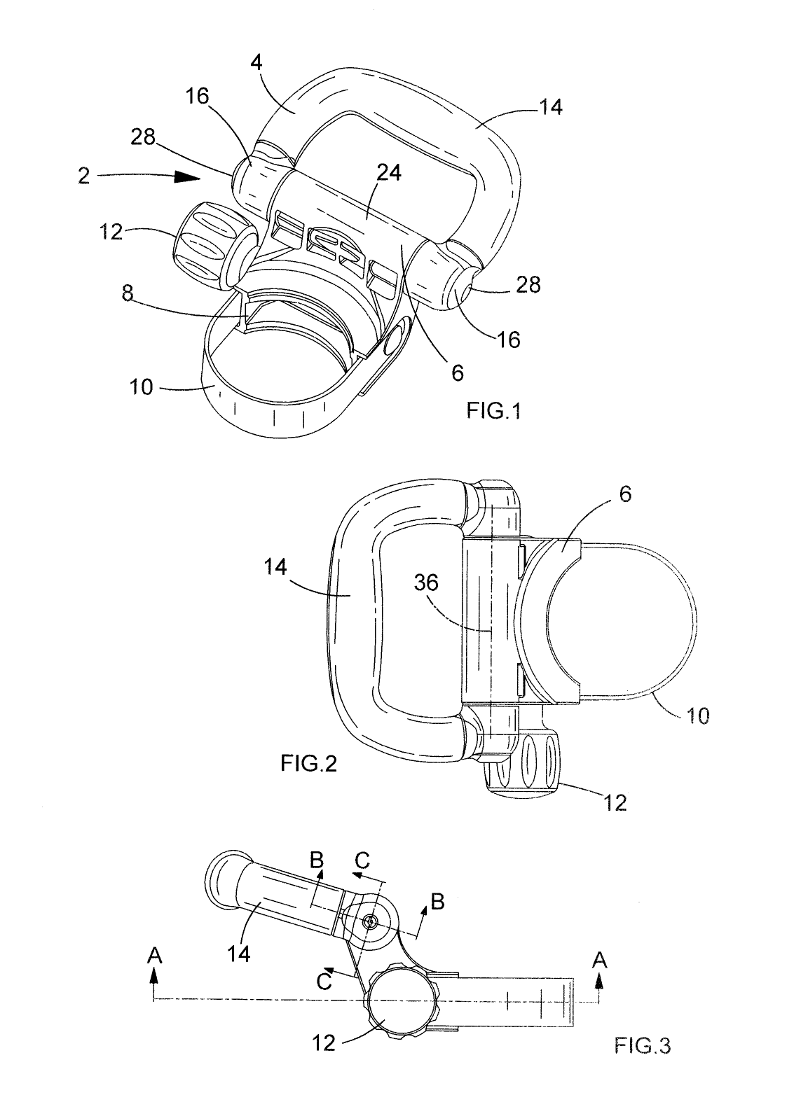

Referring to FIGS. 1 to 6, a handle assembly 2 for mounting a handle 4 to a forward part of a housing (not shown) of a power tool such as a hammer drill comprises a support member comprising a base 6 of durable plastics material having a generally partially cylindrical part 8 for abutting the housing of the power tool, and a flexible metal strap 10 which wraps around the housing to retain the base 6 in position on the housing. The strap 10 is tightened or slackened by means of a rotatable knob 12. The handle 4 has a grip 14 of suitable plastics material and first and second mounting parts 16 pivotably attached to the base 6 by means of a torsion spring 18 (FIGS. 5 and 6). The torsion spring 18 comprises a flat sheet of resilient metal such as steel having a central enlarged portion 20 and enlarged portions 22 at its ends.

The mounting parts 16 of the handle 4 are pivotably mounted to a third mounting part 24 on the base 6 such that the enlarged portions 22 of the torsion spring 18 are received in respective first and second mounting parts 16. The enlarged portions 22 of the torsion spring 18 are attached to the first and second mounting parts 16 by means of screws 26, and the enlarged portion 20 at the centre of the torsion spring 18 is attached to the third mounting part 24 by means of a screw (not shown). The ends of the first and second mounting parts 16 are closed by end caps 28 which are slidably received in respective apertures in the mounting parts 16.

When no load is applied to the grip 14, the torsion spring 18 remains flat and the grip 14 remains in its rest position. However, when pressure is applied to the grip 14, the mounting parts 16 at the respective ends of the grip 14 cause the enlarged portions 22 at the ends of the torsion spring 18 to twist around the longitudinal axis of the torsion spring 18 relative to the enlarged portion 20 at the centre of the torsion spring 18, and twisting movement of the torsion spring 18 damps the transmission of vibrations from the body of the power tool via the base 6 to the grip 14.

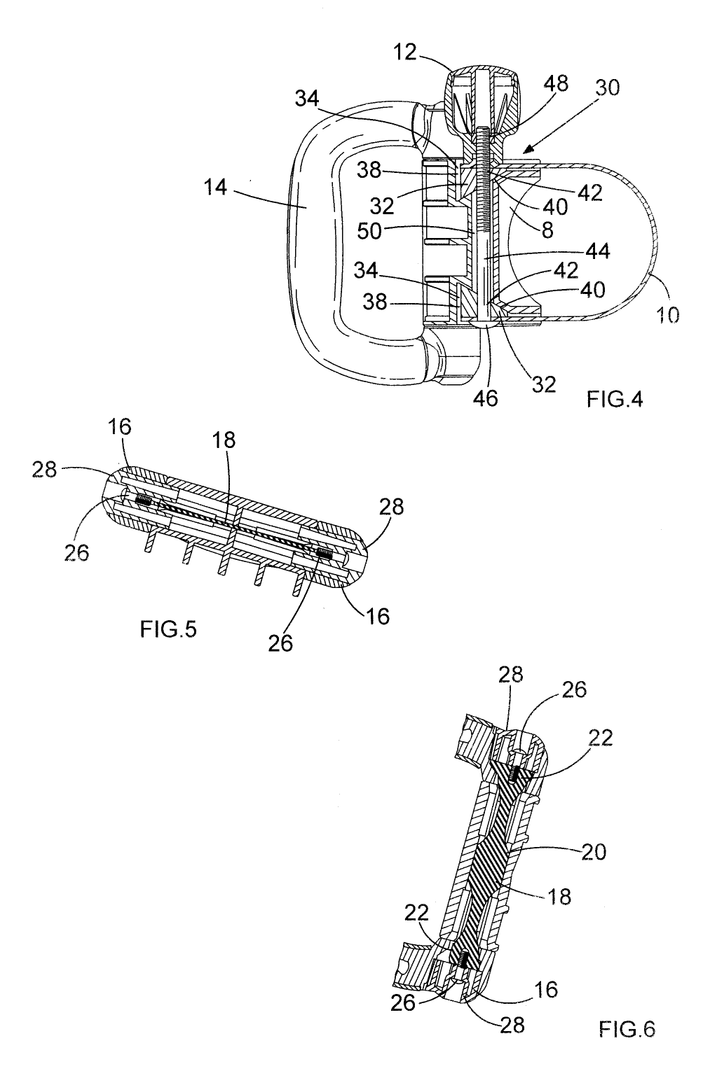

Referring now to FIG. 4, a clamping mechanism 30 for mounting the base 6 to the housing of the power tool is shown in greater detail. The clamping mechanism 30 includes a pair of wedges 32 of triangular cross section which are attached to respective ends of the metal strap 10. The wedges 32 are located in respective recesses 34 in the base 6, the length of the recess 34 in a direction transverse to the pivot axis 36 of the grip 14 being longer than the wedge 32. As a result, a gap 38 is provided between the end of the recess 34 and the end of the wedge 32, and each wedge 32 is slidable relative to the base 6 by means of inclined surfaces 40 on the base 6. Each wedge 32 is provided with an aperture 42 through which a bolt 44 passes, the bolt 44 extending from a head 46 which non-rotatably engages the external surface of the base 6, through the wedges 32 and through an aperture 50 through the base 6, and engages an internal bore 48 in the rotatable knob 12 by means of mutually engaging screw threads on the end of the bolt 44 and the internal bore 48 of the knob 12. Rotation of the knob 12 in a first direction causes the knob 12 to move axially along the bolt 44, urging the wedges 32 towards each other. As a result, the wedges 32 slide along the inclined surfaces 40 on the base 6 and move away from the part cylindrical support 8 on the base 6. This draws the ends of the metal strap 10 with the wedges 32 into the base 6, as a result of which the length of the strap 10 is shortened and the strap 10 is tightened around the housing of the power tool to clamp the handle 4 in position relative to the housing. The aperture 50 through the base 6 has an elongated cross section, such as an oval shape, to accommodate movement of the bolt 44 in a transverse direction relative to the axis 36 of rotation of the grip 14. Rotation of the knob 12 in the opposite direction enables the wedges 32 to be moved in an opposite direction relative to the base 6 to loosen the strap 10 around the housing of the tool to enable the position of the handle 4 to be adjusted.

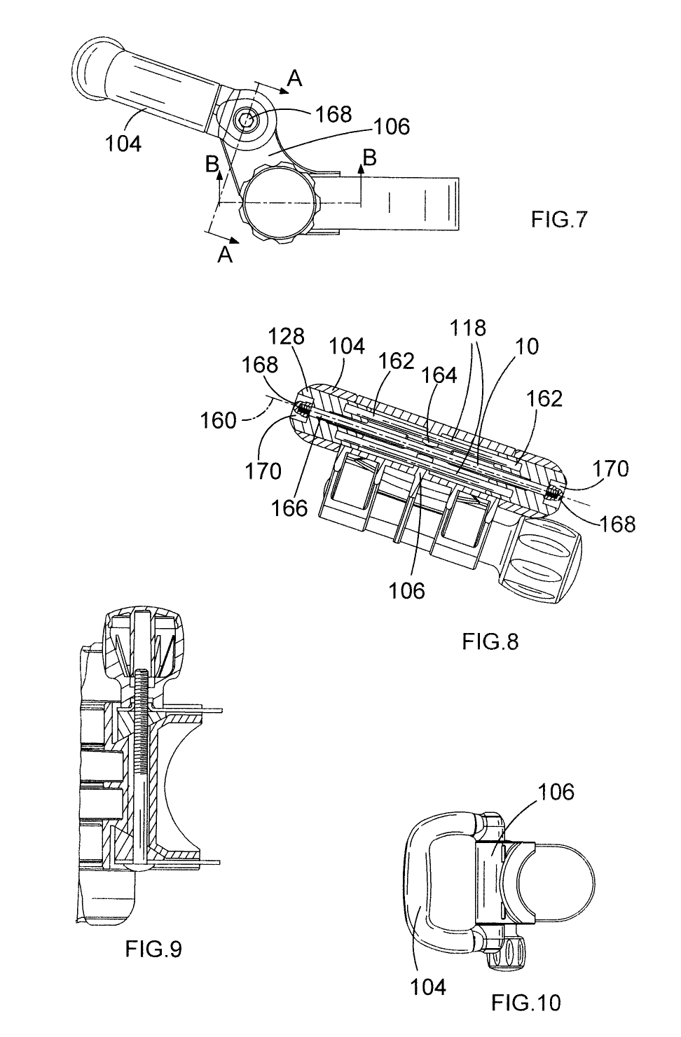

FIGS. 7 to 10 show a second embodiment of a handle assembly of the present invention, in which parts common to the embodiment of FIGS. 1 to 6 are denoted by like reference numerals but increased by 100.

In the embodiment of FIGS. 7 to 10, the torsion spring 18 of the embodiment of FIGS. 1 to 6 is replaced by a pair of spring rods 118 located parallel to and spaced from pivot axis 160 of handle 104 relative to base 106. Each end of the spring rods 118 is located in a respective recess 162 of a side handle cap 128 and engages a protrusion 164 in the side handle base 106. The side handle caps 128 are held in position by means of a threaded rod 166 extending along the pivot axis 160 and a cap nut 168 being located at each end of the threaded rod 166 in a respective recess 170 in the side handle cap 128.

As the side handle 104 is pivoted about the pivot axis 160 relative to the base 106, the spring rods 118 are bent as a result of the change in circumferential position of the recesses 162 at the ends of the rods 118 relative to the protrusions 164 between the ends of the rods 118, and the resilience of the spring rods 118 resists this pivoting motion and damps vibrations passing from the tool housing to the handle 104.

It will be appreciated by persons skilled in the art that the above embodiment has been described by way of example only and not in any limitative sense, and that various alterations and modifications are possible without departure from the scope of the invention as defined by the appended claims. For example, it is possible to replace the threaded rod 166 of the embodiment of FIGS. 7 to 10 by a rod having a single screw thread and a single cap nut 168 at one end.

1. A mounting apparatus for mounting a handle to a power tool, the apparatus comprising:
a support for supporting a handle and engaging a body of the power tool;
a flexible member for engaging the support at first and second locations to form a loop for retaining the support in engagement with the body of the power tool;
a retaining mechanism comprising a pair of first members for engaging the support and the flexible member, and retaining means for retaining the first members in position relative to the support; and
adjustment means for causing movement of said first members relative to each other in a first direction to reduce the size of said loop and in a second direction to increase the size of said loop.

2. An apparatus according to claim 1, wherein said first members are mounted in use adjacent respective ends of said flexible member.

3. An apparatus according to claim 1, wherein at least one said first member is slidable relative to said support.

4. An apparatus according to claim 3, wherein at least one said first member is slidable relative to said support by means of mutually engaging surfaces on said first member and said support.

5. An apparatus according to claim 1, wherein the retaining means comprises at least one retaining member for engaging said first members.

6. An apparatus according to claim 5, wherein at least one said retaining member is adapted to pass through a respective aperture through each said first member.

7. An apparatus according to claim 5, wherein the adjustment means engages at least one said retaining member to cause at least one said first member to move relative to said support.

8. An apparatus according to claim 7, wherein the adjustment means engages said retaining member by means of respective screw threads provided on said retaining means and said retaining member.

9. A handle mechanism comprising a mounting apparatus according to claim 1, and a handle mounted to said support.
